(19) United States
(12) Patent Application Publication
(10) Pub. No.: US 2024/0092148 A1
(43) Pub. Date: Mar. 21, 2024

(54) VEHICULAR AIR CONDITIONING SYSTEM

(71) Applicant: HANON SYSTEMS CO., LTD., Daejeon (KR)

(72) Inventors: Chan Young LEE, Daejeon (KR); Sung Jin KIM, Daejeon (KR); Young In KIM, Daejeon (KR); Jun Min LEE, Daejeon (KR)

(21) Appl. No.: 18/274,285

(22) PCT Filed: Aug. 8, 2022
(86) PCT No.: PCT/KR2022/011742

§ 371 Date: Jul. 26, 2023

(30) Foreign Application Priority Data
Aug. 13, 2021 (KR) 10-2021-0107268

(51) Int. Cl. B60H 3/06

(52) U.S. Cl. CPC B60H 3/0658; B60H 2003/0675; B60Y 2306/09

(57) ABSTRACT

Vehicular air conditioning system improving the ease of assembly and the maintainability of a photocatalyst module by structural improvement of an intake case and suppressing an air vortex generated at the air intake side during air intake process in a blower and a rumbling noise caused by the air vortex.

The vehicular air conditioning system includes an intake part configured to suck indoor or outdoor air and blow air into a vehicle interior, a photocatalyst module purifying the air by emitting superoxide radicals toward the air blown into the vehicle interior from the intake part, which is installed on a downstream outer surface portion of a blower casing of the intake part, and an interference avoidance groove for avoiding interference with the photocatalyst module is formed on an outer surface portion of the intake case corresponding to the periphery of the photocatalyst module installed in the blower casing.

### TECHNICAL FIELD

The present invention relates to a vehicular air conditioning system, and more particularly, a vehicular air conditioning system capable of improving the ease of assembly and the maintainability of a photocatalyst module through the structural improvement of an intake case and suppressing an air vortex generated at the air intake side during an air intake process in a blower and a rumbling noise caused by the air vortex.

### BACKGROUND ART

As shown in FIG. 1, a vehicle includes an air conditioning system for cooling and heating a vehicle interior.

The air conditioning system includes an intake part 10 that sucks an indoor air or an outdoor air and blows the air into the vehicle interior, and a heat exchanger part 20 that cools or heats the air blown into the vehicle interior.

The intake part 10 includes an intake case 12. The intake case 12 includes an indoor air inlet 12a, an outdoor air inlet 12b, and an intake door (not shown) arranged between the indoor air inlet 12a and the outdoor air inlet 12b.

The indoor air inlet 12a communicates with the vehicle interior to introduce an air existing inside the vehicle, and the outdoor air inlet 12b communicates with the vehicle exterior to introduce an air existing outside the vehicle.

The intake door is a dome-shaped door that rotates between the outdoor air inlet 12b and the indoor air inlet 2a to selectively open the outdoor air inlet 12b or the indoor air inlet 12a so that the outdoor air and the indoor air can be introduced selectively.

In addition, the intake part 10 includes an air filter 14 and a blower 16.

The air filter 14 is configured to filter foreign substances in the indoor air or the outdoor air introduced through the indoor air inlet 12a and the outdoor air inlet 12b.

The blower 16 is provided with a blower casing 16a and a blower fan 16b. The blower 15 sucks an indoor air or an outdoor air into the blower casing 16a through the indoor air inlet 12a or the outdoor air inlet 12b and blows the indoor air or the outdoor air toward the heat exchanger part 20 through a downstream expansion portion 16c.

In addition, the intake part 10 further includes a photocatalyst module 30 for improving the quality of an air blown into the vehicle interior.

The photocatalyst module 30 is provided with a light source part (not shown) and a catalyst part (not shown). The photocatalyst module 30 generates superoxide radicals by inducing a photocatalytic reaction in the catalyst part through the use of visible light of the light source part, and removes odors, germs and various contaminants in the air blown into the vehicle interior through the use of superoxide radicals.

The photocatalyst module 30 is installed in the intake case 12 between the intake part 10 and the heat exchanger part 20. In particular, the photocatalyst module 30 is installed on the outer surface of the downstream expansion portion 16c of the blower casing 16a in the intake case 12 between the intake part 10 and the heat exchanger part 20.

Typically, the photocatalyst module 30 is threadedly coupled to the upper side portion in the gravitational direction on the outer surface portion of the downstream expansion portion 16c of the blower casing 16a by the thread fastening portions 32. The photocatalyst module 30 thus threadedly coupled is fixedly installed on the upper part of the side surface of the expansion portion 16c of the blower casing 16a.

Meanwhile, the photocatalytic module 30 is arranged at a high density together with other peripheral parts. In particular, the screw fastening portions 32 of the photocatalyst module 30 are densely arranged together with one side portion 12c of the intake case 12 in which the air filter 14 is built.

At this time, one side portion 12c of the intake case 12 is inclined at a predetermined angle in conformity with the inclined expansion structure of the expansion portion 16c to prevent interference between the photocatalyst module 30 and the expansion portion 16c of the blower casing 16a.

In this regard, since one side portion 12c of the intake case 12 corresponding to the photocatalyst module 30 is formed to be inclined at the predetermined angle, the inner portion 12d (hereinafter referred to as “inclined portion 12d”) of the intake case 12 corresponding thereto is also inclined in a shape opposite to the inclined one side portion 12c.

Since the inner portion of the intake case 12 corresponding to the photocatalyst module 30 is formed of the inclined portion 12d as described above, the air passing through the one side portion 14a of the bottom surface of the air filter 14 flows into the air path on the side of the air inlet 16d of the blower casing 16a along the inclined portion 12d.

However, in this conventional air conditioning system, due to the structure of the inner inclined portion 12d of the intake case 12, a vortex is generated at the air inlet 16d when an air is sucked by the blower 16. The vortex thus generated causes a rumbling noise.

That is, as shown in FIG. 1, when the blower 16 is operated, the air passing through the one side portion 14a of the air filter 14 is rapidly moved along the inner inclined portion 12d of the intake case 12 and is sucked into the air inlet 16d of the blower 16.

At this time, the air rapidly moving toward the air inlet 16d along the inclined portion 12d is quickly diverted radially outward with respect to the inlet ring 16d-1 on the side of the air inlet 16d. In this quick diverting process, a vortex is generated at the air inlet 16d.

Therefore, a rumbling noise is generated at the air inlet 16d. This may reduce the ride comfort in the vehicle interior.

In addition, in the conventional air conditioning system, when assembling the photocatalyst module 30 to the expansion portion 16c of the blower casing 16a, the assembly work is difficult to perform because the assembly space is very narrow.

In particular, the photocatalyst module 30 is densely arranged with the side portion 12c of the intake case 12 and the blower casing 16a. Due to this high-density arrangement structure, the assembly tool for the photocatalyst module 30 interferes with the surrounding intake case 12. This interference makes it difficult to assemble the photocatalyst module 30.

In addition, when the photocatalyst module 30 needs to be replaced or repaired, the photocatalyst module 30 must be separated from the intake case 12. However, it is difficult to separate the photocatalyst module 30.

As a result, in the conventional air conditioning system, the ease of assembly and the maintainability of the photocatalyst module 30 are significantly deteriorated.

### SUMMARY

In view of the problems inherent in the related art, it is an object of the present invention to provide a vehicular air conditioning system capable of, through the improvement of a structure of an inner inclined portion of an intake case, suppressing an air vortex generated at the air intake side during an air intake process in a blower and a rumbling noise caused by the air vortex.

Another object of the present invention is to provide a vehicular air conditioning system capable of improving the ride comfort in a vehicle interior by suppressing an air vortex generated at the air intake side during an air intake process in a blower and a rumbling noise caused by the air vortex.

A further object of the present invention is to provide a vehicular air conditioning system capable of sufficiently securing an assembly space for assembling a photocatalyst module by improving the structure of an intake case around the photocatalyst module assembly region.

A still further object of the present invention is to provide a vehicular air conditioning system capable of facilitating the assembly and separation of a photocatalyst module through an assembly space by sufficiently securing the assembly space for assembling the photocatalyst module.

A yet still further object of the present invention is to provide a vehicular air conditioning system capable of improving the ease of assembly and the maintainability of a photocatalyst module by facilitating the assembly and separation of the photocatalyst module.

In order to achieve these objects, there is provided a vehicular air conditioning system, including: an intake part configured to suck an indoor air or an outdoor air and blow the air into a vehicle interior; and a photocatalyst module configured to purify the air by emitting superoxide radicals toward the air blown into the vehicle interior from the intake part, wherein the photocatalyst module is installed on a downstream outer surface portion of a blower casing of the intake part, and an interference avoidance groove for avoiding interference with the photocatalyst module is formed on an outer surface portion of the intake case corresponding to the periphery of the photocatalyst module installed in the blower casing.

The photocatalyst module may be assembled to the downstream outer surface portion of the blower casing by a screw fastening portion, and the interference avoidance groove may be formed in a portion of the outer surface portion of the intake case around the photocatalyst module corresponding to the screw fastening portion of the photocatalyst module.

The interference avoidance groove may be formed on the outer surface portion of the intake case corresponding to the screw fastening portion of the photocatalyst module, so that a workspace having a certain size can be secured between the intake case and the screw fastening portion.

The interference avoidance groove may be formed by inwardly recessing the outer surface portion of the intake case corresponding to the screw fastening portion of the photocatalyst module.

The outer surface portion of the intake case corresponding to the screw fastening portion of the photocatalyst module may correspond to an air flow path extending from one side portion of a bottom surface of an air filter inside the intake part to an air inlet of the blower casing, and the interference avoidance groove may be formed on the outer surface portion of the intake case corresponding to an air flow path extending from the one side portion of the bottom surface of the air filter to the air inlet of the blower casing.

The inner portion of the intake case corresponding to the screw fastening portion of the photocatalyst module may include an inclined portion inclined at a predetermined angle from the one side portion of the bottom surface of the air filter toward the air inlet of the blower casing, and the system may further include: an air flow regulation portion configured to regulate the flow of an air flowing along the inclined portion when the air passing through the one side portion of the air filter flows along the inclined portion of the inner surface portion of the intake case.

The air flow regulation portion may include a stepped portion formed on the inclined portion of the intake case so that the flow velocity and flow direction of the air flowing along the inclined portion of the intake case can be changed when the air falls by a predetermined height.

According to the vehicular air conditioning system of the present invention, the interference avoidance groove is formed in the intake case around the fastening part of the photocatalyst module. Therefore, a workspace having a certain size can be secured around the fastening part of the photocatalyst module.

In addition, since the workspace having a certain size can be secured around the fastening part of the photocatalyst module, the assembly tool can be accommodated in the workspace during the process of assembling and separating the photocatalyst module. This makes it possible to smoothly perform the work of assembling or separating the photocatalyst module with the work tool.

In addition, since the work of assembling or separating the photocatalyst module can be smoothly performed with the work tool, it is possible to improve the ease of assembly and the maintainability of the photocatalyst module.

In addition, since the air flow regulation portion is formed on the inner inclined portion of the intake case, it is possible for the air flow regulation portion to change the flow velocity and flow direction of the air sucked from the inclined portion to the air inlet of the blower.

In addition, since the flow velocity and flow direction of the air sucked from the inclined portion to the air inlet of the blower can be changed, it is possible to suppress an air vortex generated at the air inlet due to the excessive flow rate at the air inlet and the resultant rumbling noise.

In addition, since the air vortex and the rumbling noise can be suppressed at the air inlet, it is possible to improve the ride comfort in the vehicle interior.

### BRIEF DESCRIPTION OF THE DRAWINGS

FIG. 1 is a cross-sectional view showing a conventional vehicular air conditioning system.

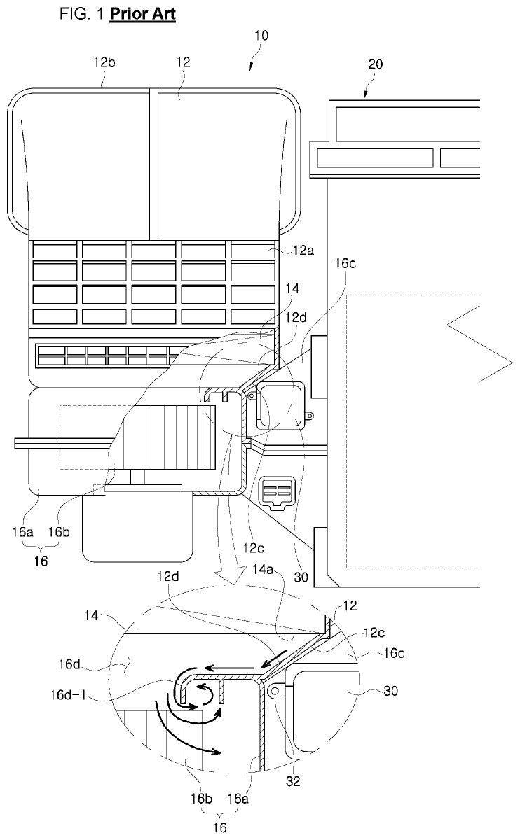

FIG. 2 is a cross-sectional view showing a vehicular air conditioning system according to the present invention.

FIG. 3 is a perspective view specifically showing the main features of the vehicular air conditioning system according to the present invention.

### DETAILED DESCRIPTION

A preferred embodiment of a vehicular air conditioning system according to the present invention will now be described in detail with reference to the accompanying drawings.

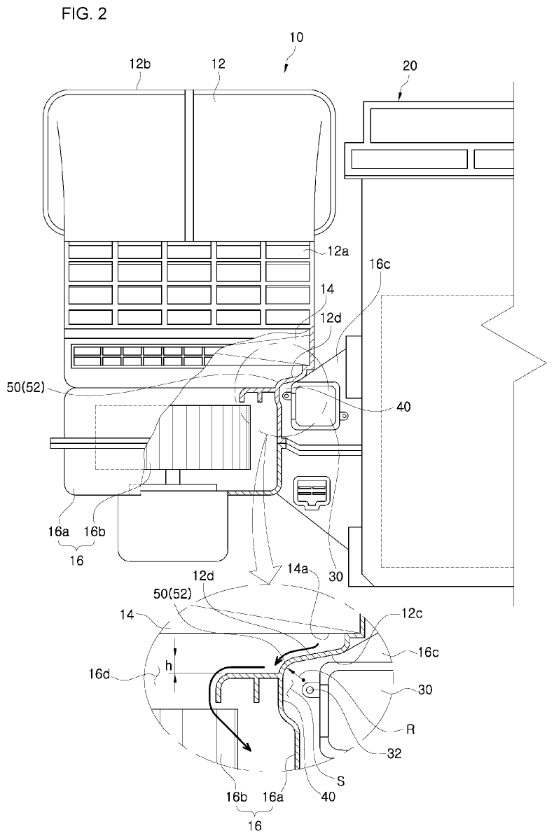

Prior to describing the features of the vehicular air conditioning system according to the present invention, the vehicular air conditioning system will be briefly described with reference to FIG. 2.

The air conditioning system includes an intake part 10 that sucks an indoor air or an outdoor air and blows the air into the vehicle interior, and a heat exchanger part 20 that cools or heats the air blown into the vehicle interior.

The intake part 10 includes an intake case 12. The intake case 12 includes an indoor air inlet 12a, an outdoor air inlet 12b, and an intake door (not shown) arranged between the indoor air inlet 12a and the outdoor air inlet 12b.

In addition, the intake part 10 includes an air filter 14 and a blower 16.

The blower 16 is provided with a blower casing 16a and a blower fan 16b. The blower 15 sucks an indoor air or an outdoor air into the blower casing 16a through the indoor air inlet 12a or the outdoor air inlet 12b and blows the indoor air or the outdoor air toward the heat exchanger part 20 through a downstream expansion portion 16c.

In addition, the intake part 10 further includes a photocatalyst module 30 for improving the quality of an air blown into the vehicle interior.

The photocatalyst module 30 is provided with a light source part (not shown) and a catalyst part (not shown). The photocatalyst module 30 generates superoxide radicals by inducing a photocatalytic reaction in the catalyst part through the use of visible light of the light source part, and removes odors, germs and various contaminants in the air blown into the vehicle interior through the use of superoxide radicals.

The photocatalyst module 30 is installed on the outer surface of the downstream expansion portion 16c of the blower casing 16a of the intake part 10. At this time, the fastening portions of the photocatalyst module 30 are fixedly installed on the upper part of the side surface of the downstream expansion portion 16c of the blower casing 16a by screw fastening.

Meanwhile, the screw fastening portions 32 of the photocatalyst module 30 are densely arranged together with one side portion 12c of the intake case 12 in which the air filter 14 is built.

At this time, one side portion 12c of the intake case 12 is inclined at a predetermined angle to prevent interference with the photocatalyst module 30.

In this regard, since one side portion 12c of the intake case 12 corresponding to the photocatalyst module 30 is formed to be inclined, the inner portion of the intake case 12 corresponding thereto also has an inclined portion 12d.

Since the inner portion of the intake case 12 corresponding to the photocatalyst module 30 is formed of the inclined portion 12d, the air passing through the one side portion 14a of the bottom surface of the air filter 14 flows into the air path on the side of the air inlet 16d of the blower casing 16a along the inclined portion 12d.

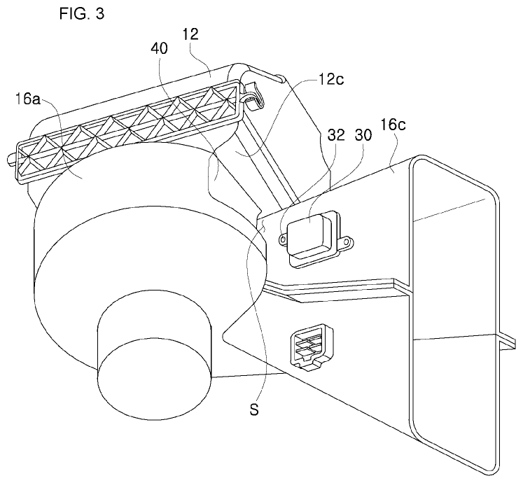

Next, features of the vehicular air conditioning system according to the present invention will be described in detail with reference to FIGS. 2 and 3.

First, the vehicular air conditioning system of the present invention includes an interference avoidance groove 40 formed on the outer surface of the intake case 12 around the photocatalyst module 30 installed in the expansion portion 16c of the blower casing 16a.

The interference avoidance groove 40 is formed in a portion of the outer surface of the intake case 12 around the photocatalyst module 30, which corresponds to the fastening portion 32 of the photocatalyst module 30.

In this regard, the outer surface portion of the intake case 12 corresponding to the fastening portion 32 of the photocatalyst module 30 corresponds to the air flow path extending from one side portion 14a of the bottom surface of the air filter 14 inside the intake case 12 to the air inlet 16d of the blower casing 16a.

Therefore, the interference avoidance groove 40 is formed on the outer surface portion of the intake case 12 corresponding to the air flow path extending from one side portion 14a of the bottom surface of the air filter 14 to the air inlet 16d of the blower casing 16a.

Since the interference avoidance groove 40 is formed on the outer surface portion of the intake case 12 around the photocatalyst module 30, it is possible to prevent interference between the photocatalyst module 30 and the intake case 12.

In particular, when assembling and separating the photocatalyst module 30 to and from the expansion portion 16c of the blower casing 16a, it is possible to prevent interference between the photocatalyst module 30 and the intake case 12.

Therefore, the assembly and separation operations of the photocatalyst module 30 can be performed more easily.

In addition, since the interference avoidance groove 40 is formed to correspond to the fastening portion 32 of the photocatalyst module 30, a workspace S having a certain size can be secured around the fastening portion 32 of the photocatalyst module 30.

Therefore, when assembling and separating the photocatalyst module 30, an assembly tool can be accommodated in the workspace S.

Accordingly, when assembling and separating the photocatalyst module 30, the assembling and separating operations can be performed smoothly using a work tool. As a result, it is possible to improve the ease of assembly and the maintainability of the photocatalyst module.

Meanwhile, the interference avoidance groove 40 is formed by inwardly recessing a portion of the intake case 12 corresponding to the fastening portion 32 of the photocatalyst module 30.

In particular, it is preferable to form the interference avoidance groove 40 by recessing a portion of the intake case 12 into a shape corresponding to the shape of the fastening portion 32 of the photocatalyst module 30.

Referring again to FIGS. 2 and 3, the vehicular air conditioning system of the present invention further includes an inclined-portion-side air flow regulation portion 50 configured to regulate the flow of an air passing through one side portion 14a of the air filter 14 and then flowing toward the air inlet 16d of the blower 16 along the inner inclined portion 12d of the intake case 12.

The inclined-portion-side air flow regulation portion 50 includes a stepped portion 52 formed on the inner inclined portion 12d of the intake case 12.

The stepped portion 52 is formed to stepped at a certain height h with respect to a portion of the inclined portion 12d of the intake case 12 on the air inlet 16d of the blower 16.

The stepped portion 52 allows the air passing through the one side portion 14a of the air filter 14 to fall by a predetermined height h when the air rapidly flows along the inclined portion 12d of the intake case 12.

Accordingly, the velocity and direction of the air flowing rapidly along the inclined portion 12d can be changed due to the provision of the stepped portion 52.

Thus, the air vortex generated at the air inlet 16d of the blower 16 can be suppressed by changing the flow velocity and flow direction of the air sucked into the air inlet 16d of the blower 16.

As a result, the air vortex generated at the air inlet 16d of the blower 16 and the rumbling noise caused by the air vortex can be suppressed to thereby improve the ride comfort in the vehicle interior.

In this regard, the stepped portion 52 is formed to be stepped at a predetermined height h on the inclined portion 12d. Preferably, the stepped portion 52 is gently stepped at a predetermined curvature R. This is to prevent quick changes in the flow velocity and flow direction of the air flowing along the stepped portion 52.

Meanwhile, the stepped portion 52 is formed stepwise toward the inside of the intake case 12 as the interference avoidance groove 40 is formed on the outer surface of the intake case 12 corresponding to the inner inclined portion 12d of the intake case 12.

In particular, the interference avoidance groove 40 is formed by inwardly recessing the outer surface portion of the intake case 12. In the process of forming the interference avoidance groove 40, the inner inclined portion 12d of the intake case 12 protrudes in a shape opposite to the shape of the interference avoidance groove 40.

According to the vehicular air conditioning system of the present invention having such a configuration, the interference avoidance groove 40 is formed in the intake case 12 around the fastening portion 32 of the photocatalyst module 30. Therefore, a workspace S having a certain size can be secured around the fastening portion 32 of the photocatalyst module 30.

In addition, since the workspace S having a certain size can be secured around the fastening portion 32 of the photocatalyst module 30, the assembly tool can be accommodated in the workspace S in the process of assembling and separating the photocatalyst module 30. This makes it possible to smoothly perform the assembly and separation operations of the photocatalyst module 30 through the use of the work tool.

In addition, since the assembly and separation operations of the photocatalyst module 30 can be smoothly performed through the use of the work tool, it is possible to improve the ease of assembly and the maintainability of the photocatalyst module 30.

In addition, since the air flow regulation portion 50 is formed on the inner inclined portion 12d of the intake case 12, the flow velocity and flow direction of the air sucked from the inclined portion 12d to the air inlet 16d of the blower 16 can be changed through the use of the air flow regulation portion 50.

In addition, since the flow velocity and flow direction of the air sucked from the inclined portion 12d to the air inlet 16d of the blower 16 can be changed, it is possible to suppress the air vortex generated at the air inlet 16d due to the severe change in the flow velocity and flow direction of the air and the resultant rumbling noise.

Further, since the air vortex and the rumbling noise can be suppressed at the air inlet 16d, it is possible to improve the ride comfort in the vehicle interior.

While the preferred embodiments of the present invention have been described above, the present invention is not limited to the above-described embodiments. Various modifications and changes may be made without departing from the scope and spirit of the present invention defined in the claims.

### DESCRIPTION OF REFERENCE NUMERALS

10: intake part, 12: intake case, 12a: indoor air inlet, 12b: outdoor air inlet, 12c: one side portion of intake case, 14: air filter, 14a: one side portion of air filter, 16: blower, 16a: blower casing (scroll casing), 16b: blower fan, 16c: expansion portion, 16d: air inlet, 16d-1: inlet ring, 20: heat exchanger part, 30: photocatalyst module, 40: interference avoidance groove, 50: air flow regulation portion, 52: stepped portion

1. A vehicular air conditioning system, comprising:
an intake part configured to suck an indoor air or an outdoor air and blow the air into a vehicle interior; and
a photocatalyst module configured to purify the air by emitting superoxide radicals toward the air blown into the vehicle interior from the intake part,
wherein the photocatalyst module is installed on a downstream outer surface portion of a blower casing of the intake part, and
an interference avoidance groove for avoiding interference with the photocatalyst module is formed on an outer surface portion of the intake case corresponding to the periphery of the photocatalyst module installed in the blower casing.

2. The system of claim 1, wherein the photocatalyst module is assembled to the downstream outer surface portion of the blower casing by a screw fastening portion, and
the interference avoidance groove is formed in a portion of the outer surface portion of the intake case around the photocatalyst module corresponding to the screw fastening portion of the photocatalyst module.

3. The system of claim 2, wherein the interference avoidance groove is formed on the outer surface portion of the intake case corresponding to the screw fastening portion of the photocatalyst module, so that a workspace having a certain size can be secured between the intake case and the screw fastening portion.

4. The system of claim 3, wherein the interference avoidance groove is formed by inwardly recessing the outer surface portion of the intake case corresponding to the screw fastening portion of the photocatalyst module.

5. The system of claim 2, wherein the outer surface portion of the intake case corresponding to the screw fastening portion of the photocatalyst module corresponds to an air flow path extending from one side portion of a bottom surface of an air filter inside the intake part to an air inlet of the blower casing, and
the interference avoidance groove is formed on the outer surface portion of the intake case corresponding to an air flow path extending from the one side portion of the bottom surface of the air filter to the air inlet of the blower casing.

6. The system of claim 5, wherein the interference avoidance groove is formed by inwardly recessing the outer surface portion of the intake case corresponding to the air flow path extending from the one side portion of the bottom surface of the air filter to the air inlet of the blower casing.

7. The system of claim 6, wherein the inner portion of the intake case corresponding to the screw fastening portion of the photocatalyst module includes an inclined portion inclined at a predetermined angle from the one side portion of the bottom surface of the air filter toward the air inlet of the blower casing, and further comprising:
an air flow regulation portion configured to regulate the flow of an air flowing along the inclined portion when the air passing through the one side portion of the air filter flows along the inclined portion of the inner surface portion of the intake case.

8. The system of claim 7, wherein the air flow regulation portion includes a stepped portion formed on the inclined portion of the intake case so that the flow velocity and flow direction of the air flowing along the inclined portion of the intake case can be changed when the air falls by a predetermined height.

9. The system of claim 8, wherein the stepped portion is formed to be stepped at the predetermined height with respect to a portion of the inclined portion of the intake case on the side of the air inlet of the blower casing.

10. The system of claim 9, wherein the stepped portion is stepped gently at a predetermined curvature and at the predetermined height with respect to the inclined portion of the intake case on the side of the air inlet of the blower casing.

11. The system of claim 10, wherein the stepped portion protrudes in a shape opposite to the shape of the interference avoidance groove as the interference avoidance groove is formed by inwardly recessing the outer surface portion of the intake case corresponding to the inclined portion of the intake case.
